(19) United States
(12) Patent Application Publication
(10) Pub. No.: US 2016/0072771 A1
(43) Pub. Date: Mar. 10, 2016

(54) HEALTH AND OTHER USE OF COLLECTION OF ARCHIVAL DIGITAL DATA

(71) Applicant: Mark Krietzman, Palos Verdes Estates, CA (US)

(72) Inventor: Mark Krietzman, Palos Verdes Estates, CA (US)

(21) Appl. No.: 14/846,402

(22) Filed: Sep. 4, 2015

Related U.S. Application Data
(60) Provisional application No. 62/047,060, filed on Sep. 8, 2014.
(60) Provisional application No. 62/184,361, filed on Jun. 25, 2015.

(51) Int. Cl. H04L 29/06; G06Q 30/02; G06F 17/30

(52) U.S. Cl. CPC H04L 63/04; G06F 17/30312; G06Q 30/0277; H04L 63/08

(57) ABSTRACT

A secure digital content collection method, including a server being in signal communications with an application on a computing device; using a computing device to capture digital data about a Collection-Target such as a child or elderly person and deposit the data in a secure vault. Using alerts and/or lock-out on a computing device to encourage collection of digital data. The collected data may be processed into a variety of different criteria reels of data for a user to review. The collected data may be used for marketing and advertising purposes.

### CROSS-REFERENCE TO RELATED APPLICATION

This application claims the priority to United States (“U.S.”) Provisional Patent Application Ser. No. 62/047,060, titled “Family Archive System and Method” filed on Sep. 8, 2014, to inventor Mark Krietzman, and Provisional Patent Application Ser. No. 62/184361 SYSTEM AND METHOD TO MONITOR FAMILY MEMBERS AND COLLECT DIGITAL MEDIA AND RESPONSES filed Jun. 25, 2015 to Mark Krietzman the disclosures of which are incorporated by reference herein in their entirety.

### BACKGROUND OF THE INVENTION

1. Field of the Invention

The present disclosure relates generally to capture, use and release of digital media data its use in health and safety and remote archive.

2. Related Art

Smart phones, computers, smart televisions, in home platforms systems such as JIBO™ and ECHO™ can collect digital media such as audio, video, still photo, fingerprints, voices, biometrics and interact with a user. Such devices can be in signal communication with a network.

Microsoft's health vault is a platform to agglomerate health care information from providers with sharing aspects.

A data management platform or “DMP” is in a sense a data warehouse. It utilizes software that collects, sorts and houses information, and it can search for data or trends that are useful for marketers, publishers and other businesses. DMPs often manage cookie IDs and can generate audience segments, which are subsequently used to target specific users with online ads.

A “DSP” is a demand-side platform is a piece of software used to purchase advertising in an automated fashion. DSPs are most often used by advertisers and agencies to help them buy display, video, mobile and search ads. DSPs allow advertisers to buy advertising impressions across a range of publisher sites, but attempt to better target specific users based on information such as their location and their previous browsing behavior. Publishers make their ad impressions available through marketplaces called ad exchanges, and DSPs automatically decide which publisher or impressions it makes the most sense for an advertiser to buy at a given time. Often the price of those impressions is determined by a real-time auction, through a process known as real-time bidding

### SUMMARY

At present, people generate and receive an enormous quantity of digital media in a life, year, day, hour, moment. People also interact online with others, websites, accounts secure and insecure sites. Robots, drones, JIBO™, home surveillance system may be autonomous or semi-autonomous and may have digital capture assets associated therewith.

Our digital footprints are our legacy for our friends and family. However, it is hard to know or find the needle in the haystack.

Time demands on parents may leave them wondering where the time went and why the did not do a better job collecting the digital experience of their children via digital media while they were young. According to aspects of exemplary implementations disclosed herein a parent's CD has an application installed thereon which reminds alerts and directs a parent to collect such digital media of a child. Such collections may include be responses to prompts, cues, questions or the like provided via the CD. Collection is uploaded via a network to a secure server visa via appropriate authentication and verification modules and technologies. Said upload may be encrypted. The collected digital media may be processed, analyzed, parsed and utilized for a plethora of reasons. A non-exclusive list includes historically archive, making compilations, predictive collections, marketing and advertising,

Children, the infirm, disabled, injured, elderly person and guardian, assistants and caregivers thereto (population of objects “POO”) also sometime referred to as Collection-Targets (which is a larger group they may be a subset of), may be accessed with smart phones, tablets, wearable device, JIBO™, ECHO™ other robots and drones all of which are considered computing devices CD. According to aspects of exemplary implementations disclosed herein a POO's CD is in signal communication with a network, such CD's have processors, software, applications and hardware. A POO has a CD according to aspects of the disclosure with an application installed thereon which reminds alerts and directs the POO to collect such digital media. Such collections may include be responses to prompts, cues, questions or the like provided via the POO's CD. Collection is uploaded via a network to a secure server visa via appropriate authentication and verification modules and technologies. Said upload may be encrypted. The collected digital media may be processed, analyzed, parsed and utilized for a plethora of reasons. A non-exclusive list includes safety, security, historically archive, making compilations, predictive collections, marketing and advertising.

A nanny, teacher, assistant or child's caregiver, elderly persons assistant and/or caregiver, sick persons assistant/caregiver or the like (population of third parties collectors for a POO “PTP” also referred to, in some instance, as Collectors) may be accessed with smart phones, tablets, wearable device all of which are considered computing devices CD. According to aspects of exemplary implementations disclosed herein a PTP's CD is in signal communication with a network. The CD has processors, software, applications and hardware. A PTP has a CD according to aspects of the disclosure with an application installed thereon which reminds alerts and directs the PTP to collect such digital media of a child, elderly or sick person. Such collections may include be responses to prompts, cues, questions or the like provided via the PTP's CD. Collection is uploaded via a network to a secure server visa via appropriate authentication and verification modules and technologies. Said upload may be encrypted. The collected digital media may be processed, analyzed, parsed and utilized for a plethora of reasons. A non-exclusive list includes safety, security, historically archive, making compilations, predictive collections, marketing and advertising.

The disclosure includes a secure digital content collection method, including a server being in signal communications with an application on a computing device; using a computing device to capture digital data about a Collection-Target such as a child or elderly person and deposit the data in a secure vault. Using alerts and/or lock-out on a computing device to encourage collection of digital data. The collected data may be processed into a reel of data for a user to review. The collected data may be scraped for marketing and advertising purposes.

Aspects of some exemplary implementations disclosed herein include providing a digital sales system “DSS” (including one or both of a DMP and DSP) with a filtered a collection of information from one or more of family archives for one or more of trends, demographic information, geolocation, activity, items, objects consumer information, religious information, and social information for marketing.

Aspects of the disclosure include personal vaults with a last message held for a designated person. Those vaults may be distributed for free to first responders throughout the Country. To defer, pay or supplement the cost for the vault offering to first responders (EMT, fire, rescue, paramedic, national guard, coast guard, police, military, and the like) the use of charitable contributions, governmental and/or corporate sponsors is anticipated.

Aspects of some exemplary implementations disclosed herein include family vaults and archives with multiple capture points and systems processing the collected information into reviewable formats.

Aspects of some exemplary implementations disclosed herein include filtering a collection of information within family archives for one or more of trends, demographic information, geolocation, activity, items, objects consumer information, religious information, and social information.

Aspects of some exemplary implementations disclosed herein include a vault with preselected release and distribution. A system and method wherein a system and method to digitally store and vault content and said content to be delivered only upon a pre identified event such as in capacitance, incarceration or death.

This disclosure provides aspects of exemplary implementations of a vault with preselected release and distribution. A system and method to collect, secure and store digital assets. Said digital asset are kept secure for vault owner. In some instances user will specify terms of delivery of access to the digital asset only upon a pre-identified event such as incapacitation, time, date, and/or death. That vault or archive may contain a last message. The vault is private, secure, and in some instances encrypted. Delivery of said message may be a private affair. In some instances delivery may be, in part, impacted by a trust or will. In some instances vault owner's has decided to transfer their digital asset(s) and have opted for a privately administered system. Servers having memory, processors and software utilizing at least decision and rule engines determine if one or more criteria for delivery or release are met. In other instance at least one delivery man or woman is designated to be another gatekeeper providing a human part of the release/delivery process of the digital asset(s). In some instances servers having memory, processors and software utilizing at least decision and rule engines identify conditions which require contact of at least one delivery entity (i.e. bank), man or woman who is designated by the user to be gatekeeper(s) of the release/delivery process.

Also disclosed are some aspects of a system and method to collect and store personal digital assets. The digital storage and collection may also include methods and systems to deliver access to one or more specific parts of such digital assets to a third party or parties upon user selected criteria. Digital assets may be collected into specific sub vaults.

Aspects of the system and method disclosed include collection, storage and distribution of digital assets which include but are not limited to audio, video, jpeg, still, documents, emails, archives of social network content of user, archives of business network content of user, archive of cloud content of vault owner.

The contents in the vault (or a subgroup of the content) will have default instructions for delivery. In some instances the delivery or release criteria for some or all of the content is based on death or in capacitance of the originator or vaultor (the person placing the digital information in the vault). In some instances the instructions for delivery or distribution of some or all content is based on a date or time. In some instances the delivery or distribution of some or all content is based on rule and/or decision engines of a server based on following instruction of the originator. In some instances the release, delivery or distribution of some or all content is based on rule and/or decision engines of a server and one or more person(s). The contents in the vault (or a subgroup of the content) may have default instructions for delivery. In some instances the release, delivery or distribution of some or all content is based on the selected person or persons.

Aspects of the system and method include but are not limited to audio, video, jpeg, archives of social network, still, documents, emails, and the like for the vaultor. The contents in the vault (or a subgroup of the content) will have default instructions for delivery. In some instances the release, delivery or distribution of some or all content is based on the selected person or persons.

This disclosures provides aspects of exemplary implementations of a family vault with preselected access, transfer rights, release and/or distribution. Exemplars include a system and method wherein digitally stored content is fed to the vault be multiple authorized family members. Not all family members need have review or edit right. Rights to access and edit may be changed based on criteria or conditions such as age, time, death or incapacitation. In some instances reminders on a computer or smart phone (or other computing device) urges the originator or family member(s) to journal content for the vault(s).

This disclosures provides aspects of exemplary implementations of a friends or business vault with preselected access, transfer rights, release and/or distribution. Exemplars include a system and method wherein digitally stored content is fed to the vault be multiple authorized persons. Not all persons need have review or edit right. Rights to access and edit may be changed based on criteria or conditions such as age, time, death or incapacitation. In some instances reminders on a computer or smart phone (or other computing device) urges the originator or person with contributing rights to journal content for the vault(s).

Aspects of the system and method disclosed herein include but are not limited to a graphical user interface “GUI”, wherein a member with administrative rights, or preference setting rights to some portion of back-end “content sculpting modules” CSM of a family vault sets values or instructions for filtering, categorizing or otherwise parsing the data via the servers and rule and decisioning engines facilitate same. In some instance the servers may suggest CSM options to the user. Robotic CSM may be utilized based on one or more of keywords, image recognition, biometrics, capture device ID, RFID tags, object recognition, word recognition, subject recognition, date, time, location or key words.

Aspects of the system and method disclosed herein include but are not limited to a secure digital content collection method, of a server being in signal communications with an application on a computing device; a user utilizes the computing device to capture digital data and deposit the data in a secure vault; the user having previously configured the secure vault to release the digital data collected to one or more intended recipients only if a digital distribution condition (DDC) occurs. In some instance there may be a human or robotic gatekeeper validate if the DDC is met. In some instance a human or robotic gatekeeper validate if the intended recipient matches the users specification of the intended recipient(s).

Aspects of the system and method disclosed herein include but are not limited to a secure digital content collection method, of a server being in signal communications with an application on a computing device; the computing device receives a prompt from the server or application to collect digital data at a pre-determined time or date; the captured digital data and deposit the data in a secure vault; and, the user having previously configured the secure vault to release the digital data collected to one or more intended recipients only if a digital distribution condition (DDC) occurs.

Aspects of the system and method disclosed herein include but are not limited to a secure digital content collection method, of a server being in signal communications with an application on a person's computing device; the computing device receives a prompt from the server or application to collect digital data at a pre-determined time or date; and, the captured digital data is deposited in a secure vault server. In some instances the person's device has one or more functions interrupted until a collection takes place. The interruption may include, but not be limited to the computing device displaying or announcing information, questions, requests, and instructions. In some instance the person is elderly, in some instance the person is handicapped. In some instances the person suffers from cognitive symptoms affecting memory, speech, and/or reasoning. In some instances the person suffers from illness and the system is used to “check-in” on the person robotically. If the person does not respond to the prompt a person (or persons) associated with the collection account may be notified. If the person does not respond to the prompt an autonomous or semi-autonomous robot or drone may be notified and sent to the location of the person. The location of the person may be ascertained by an number of methods including smart phone location, GPS, wifi, RFID on or in the person or smart phone.

Aspects of the system and method disclosed herein include but are not limited to a secure digital content collection method, of a server being in signal communications with an application on a child's computing device; the computing device receives a prompt from the server or application to collect digital data at a pre-determined time or date; and, the captured digital data is deposited in a secure vault server. In some instances the child's device has one or more functions interrupted until a collection takes place. The interruption may include, but not be limited to the computing device displaying or announcing information, questions, requests, and instructions. In some instances the child is “checked-in” on robotically. If the child does not respond to the prompt a person (or persons) associated with the collection account may be notified. If the person does not respond to the prompt an autonomous or semi-autonomous robot or drone may be notified and sent to the location of the child. The location of the child may be ascertained by an number of methods including smart phone location, GPS, wifi, RFID on or in the child or smart phone.

Aspects of the system and method disclosed herein include but are not limited to a secure digital content collection method, of a server being in signal communications with an application on a child's caregivers computing device; the computing device receives a prompt from the server or application to collect digital data at a pre-determined time or date; and, the captured digital data is deposited in a secure vault server. In some instances the caregiver's device has one or more functions interrupted until a collection takes place. The interruption may include, but not be limited to the computing device displaying or announcing information, questions, requests, and instructions. In some instances the child and/or caregiver are “checked-in” on robotically. If the caregiver does not respond to the prompt a person (or persons) associated with the collection account may be notified. If the caregiver does not respond to the prompt an autonomous or semi-autonomous robot or drone may be notified and sent to the location of the caregiver and/or last known location of the child. The location of the caregiver and/or child may be ascertained by an number of methods including smart phone(s) location(s), GPS, wifi, RFID on or in the caregiver, child or smart phone(s). Those of ordinary skill in the art will recognize that the disclosure also encompasses replacing the child with an elderly or ill person who is receiving caregiver assistance.

Aspects of the system and method disclosed herein include but are not limited to a secure digital content collection method, of a server being in signal communications with an autonomous or semi-autonomous digital data collection device affixed to or provided by a robot, JIBO™, fixed digital recording device, moving digital recording device and/or drone (Collection Machines); the computing device receives a prompt from the server or application to collect digital data at a pre-determined time or date; and, the captured digital data and deposit the data in a secure vault server. In some instances the collection machine collects in real time. In some instance the collection machine collects “as needed” based on monitoring the subject for collection (person, child, animal) and collecting if a state is met or changes. In some instance the child is tracked or located for digital data collection by one or more of biometrics, RFID, electronic device on child in signal communication with collection server thereby identifying child (target) for digital data collection. In some instance a located subject has digital data collected by collection machines close enough to make a collection from the child. In some instance the child is tracked or located for digital data collection by one or more of biometrics, RFID, electronic device on child in signal communication with collection server thereby identifying child (target) for digital data collection. In some instance a located subject has digital data collected by movable collection machines which come to child's location. In some instance the child can be tracked for collection by one or more of biometrics, RFID, electronic device on child in signal communication with the microprocessor(s) associated with the collection machine thereby identifying child (target) for digital data collection.

Aspects of the system and method disclosed herein include but are not limited to a secure digital content collection method, of a server being in signal communications with an autonomous or semi-autonomous digital data collection device affixed to or provided by a robot, JIBO™, fixed digital recording device, moving digital recording device and/or drone (Collection Machines); the computing device receives a prompt from the server or application to collect digital data at a pre-determined time or date; and, the captured digital data and deposit the data in a secure vault server. In some instances the collection machine collects in real time. In some instance the collection machine collects “as needed” based on monitoring the subject for collection (person, child, animal) and collecting if a state is met or changes. In some instance the child is tracked or located for digital data collection by one or more of biometrics, RFID, electronic device on child in signal communication with collection server thereby identifying child (target) for digital data collection. In some instance a located subject has digital data collected by collection machines close enough to make a collection from the child. In some instance the child is tracked or located for digital data collection by one or more of biometrics, RFID, electronic device on child in signal communication with collection server thereby identifying child (target) for digital data collection. In some instance a located subject has digital data collected by movable collection machines which come to child's location. In some instances or movable collection machine In some instance the child can be tracked for collection by one or more of biometrics, RFID, electronic device on child in signal communication with the microprocessor(s) associated a server thereby identifying child (target) for digital data collection.

Aspects of the system and method disclosed herein include but are not limited to a secure digital content collection method comprising a secure digital content collection method, the method comprising: a server being in signal communications with an application on a child's computing device; the computing device receives a prompt from the server or application to collect digital data at a pre-determined time or date; and, the captured digital data and deposit the data in a secure vault.

Aspects of the system and method disclosed herein include but are not limited to a secure digital content collection method comprising a server being in signal communications with an autonomous or semi-autonomous digital data collection device on robot, fixed digital recording device or drone; the data collection device being a computing device; the child having a tracking or ID device thereon; the computing device receives a prompt from the server to collect digital data about the child; and, the captured digital data and deposit the data in a secure vault.

Aspects of the system and method disclosed herein include but are not limited to a secure digital content collection method comprising a server determines that a DDC has been met; the server contacts the intended recipient(s); sever authenticates the intended recipient(s); and, stored digital data is distributed to intended recipient(s).

Aspects of the system and method disclosed herein include but are not limited to a secure digital content collection method comprising a secure digital content distribution method, the method comprising: a server determines that a DDC has been met; the server contacts the intended recipient(s); sever authenticates the intended recipient(s); server provides intended recipient a digital key which may allow access to the stored digital data. In some instances the intended recipient(s) must be authenticated a second time with the digital key to receive access to stored digital data content.

Aspects of the system and method disclosed herein include but are not limited to a secure digital content collection method comprising a server determines that a DDC has been met; the server contacts a gatekeeper; the gatekeeper is authenticated by the server; if authenticated the server provides gatekeeper a digital key which may allow the intended recipient access to the stored digital data. In some instances the intended recipient using the digital key provided by the gatekeeper contacts the server via a computing device and the sever authenticates the digital key and intended recipient(s); and, the intended recipient is provide access to the secure vault.

Aspects of the system and method disclosed herein include but are not limited to a secure digital content collection method comprising a server being in signal communications with an application on a child caregiver or a child's computing device which may be a smartphone; the computing device receives a prompt from the server or application to collect digital data at a pre-determined time or date; and, the captured digital data and deposit the data in a secure vault.

Aspects of the system and method disclosed herein include but are not limited to a secure digital content collection method comprising a server being in signal communications with an application on a child caregiver or a child's computing device which may be a smartphone; and, the computing device receives a prompt from the server or application on the smartphone to collect digital data at a pre-determined time or date. In some instances the method further comprising the child or caregiver in response to the prompt either captures data and deposits it in a safe vault or does not make a data capture or deposit. In some instances the method further comprising the if the caregiver or child does not make a capture one or more functions on the smartphone of the caregiver or child are interrupted until a capture is confirmed by the application or servers. In some instances the method further comprising the if the caregiver or child does not make a deposit of a capture one or more functions on the smartphone of the caregiver or child are interrupted until the deposit is confirmed by the application or servers. In some instances notice of a failure to make a data capture or deposit which causes a interrupt is provided to a designated person.

Aspects of the system and method disclosed herein include but are not limited to a method of receiving a reel of digital data collected about a Collection-Target, the method comprising: processing digital data collected from the CD of a Collection-Target or a Collection-Target's caregiver; during processing applying filtering criteria specified by a user; and, after processing delivering the reel to the user.

Aspects of the system and method disclosed herein include but are not limited to an advertising method, the method comprising: a server being in signal communications with a secure vault server receives data and metadata scraped from deposits to the one or more secure vaults which may include device ID of depositor, meta data about the user of the device, keywords, images, locations, purchasing history, and browsing history.

Aspects of the system and method disclosed include a server being in signal communications with an application on a computing device which may be a smartphone on a member of a population of objects (POO) or on a member of a population of third parties collectors for a POO (PTP); and, the computing device receives a prompt from the server or application on the smartphone to collect digital data at a pre-determined time or date.

Aspects of the system and method disclosed include a server being in signal communications with an application on a computing device which may be a smartphone on a member of a population of objects (POO) or on a member of a population of third parties collectors for a POO (PTP); the computing device receives a prompt from the server or application on the smartphone to collect digital data at a pre-determined time or date; and, the member of the POO or PTP in response to the prompt either captures data and deposits it in a safe vault or does not make a data capture or deposit. In some instances if the member of the POO or PTP does not make a capture one or more functions on the computing device it is interrupted until a capture is confirmed by the application or servers.

Aspects of the system and method disclosed include a server being in signal communications with an application on a computing device which may be a smartphone on a member of a population of objects (POO) or on a member of a population of third parties collectors for a POO (PTP); the computing device receives a prompt from the server or application on the smartphone to collect digital data at a pre-determined time or date; and, failure to make a data capture or deposit is provided to a designated person.

Aspects of the system and method disclosed include autonomous or semi-autonomous digital data collection with one or more data collection devices on a home platform, laptop, smart TV, smartphone, robot, fixed device and drone; the data collection device also being a computing device; a server in signal communications with the digital capture device; one of the server and a timer on the collection device instructs the data collection device to collect data on a POO or PTP; the collection device identifies the POO or TPT for collection; and, whereby the collection of data from the POO or PTP is taken. In some instances the captured digital is uploaded to a secure vault. In some instances the identification of the POO or TPT is via biometrics such as face, voice, pheromones associated with the POO or TPT. In some instances the identification of the POO or TPT via the device ID of a smartphone associated with the POO or TPT. In some instances the identification of the POO or TPT via the device ID of a RFID tag associated with the POO or TPT.

Aspects of the system and method disclosed include access of uploaded content by an authorized person and/or servers filtering uploaded content according to criteria to prepare a reel for use/delivery. For reel preparation criteria are at least one of a preset, user defined, server heuristic or predictive engine selected.

Aspects of the system and method disclosed include a server being in signal communications with a secure vault server receives data and metadata collected or scraped from deposits of the one or more secure vault depositors which may include device ID of depositor, meta data about the user of the device, keywords, images, locations, purchasing history, and browsing history; and, the scraped data is used, at least in part by a data management platform and a demand-side platform. The data can be used to advertise. The server may have additional data and meta data associated with the depositor such as geolocation, age, browsing history and CD associated with depositor machine ID.

Other devices, apparatus, systems, methods, features and advantages of the inventions disclosed herein will be or will become apparent to one with skill in the art upon examination of the following figures and detailed description. It is intended that all such additional systems, methods, features and advantages be included within this description, be within the scope of the inventions, and be protected by the accompanying claims.

The disclosure may be better understood by referring to the following figures. The components in the figures are not necessarily to scale, emphasis instead being placed upon illustrating the principles of the invention. In the figures, like reference numerals designate corresponding parts throughout the different views. All callouts in all figures are hereby incorporated by references as if fully set forth herein.

### DRAWINGS

FIG. 1 is an overview of a preselected delivery safe vault system and method;

FIG. 2 is an overview of another preselected delivery safe vault system and method;

FIG. 3 is an overview of another preselected delivery safe vault system and method utilizing sub vaults;

FIG. 4 is a system overview;

FIG. 5 is a system overview;

FIG. 6 is a reminder system overview;

FIGS. 7A and 7B is a access and deliver process;

FIGS. 8A-8C are aspects of reminder to capture systems.

FIG. 9 shows aspects of a CSM for filtering capture digital data into preselected forms for delivery;

FIG. 10 is a responsive advertising and marketing module which uses collected digital data to market and advertise to individuals or some subpopulations; and,

FIG. 11 shows aspects of a processing module for targeted advertising and marketing.

### FURTHER DESCRIPTION

It is appreciated by those skilled in the art that some of the circuits, components, modules, and/or devices of the system disclosed in the present application are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying analog and/or digital formats without passing through a direct electromagnetic connection. These information paths may also include analog-to-digital conversions (“ADC”), digital-to-analog (“DAC”) conversions, data transformations such as, for example, fast Fourier transforms (“FFTs”), time-to-frequency conversations, frequency-to-time conversions, database mapping, signal processing steps, coding, modulations, demodulations, etc.

Computing devices may be computers, laptops, smart phones, tablets and devices with processors and memory in them such as drones, robots, and other device that can capture at least one audio, video, photo, biometric data, health, voice, image and gps (location) data. Such devices may be a child's stuffed animal with embedded computer, a home robot, a smart phone or a child's learning device with the capability to record the above type of information related to the user and then upload same via a wired or wireless communication to the archive.

The data captured in some instances discussed is converted to, or saved as, digital data for analysis, archiving and transmission. The vault or family archive include a first communication device (i.e. a smart phone or other computing device), a database, a server, a release/delivery decisioning process, a second communication device and one or more controller. The controller may be software operating within the sever. The communication devices, server, database are in signal communication with each other.

Overview: In a most basic form the vault allows a person to save a message for a loved one or associate (Vaultee) and secure it for delivery if that person (Vaultor) dies or is incapacitated. In a more complex version the vault can be used to store digital content to be secured for deliver upon death or incapacity. Content includes but is not limited to emails, documents, video, audio, passwords, account records, jpegs, mpegs, and records. A secure interface which may be an application (Software) on the user's computing device allows a user to tag, and store the content or to permission third party to deposit information. In a more complex variation the archive is for a family and reminders, alerts and devices interrupt are used to help train the family of Vaultor i.e. children (or the Vaultor) to archive or journal ones life in according to a schedule which may be fixed or dynamic.

In addition to vault content collected, stored and created for and by user, the user may use the vault as a legacy archive to aggregate and segregate passwords and credentials for login in to web based services, programs, and sites. When a user (Vaultor) adds an application to his/her computing device the Vaultor can specify which passwords and other login criteria (user name, IP address, MAC address, nickname, security questions) for what websites and service (banks, social networks etc.) to place in a vault or a sub vault for safe keeping. Such login in criteria for legacy use and to manage digital assets during a user's incapacity or after a Vaultor's death of the user whereby heirs and designees (Vaultees) may, upon decision of incapacity, death or other user defined data distribution condition (DDC) whereby he/she gains access to the some or all of the digital content of the safe vault(s). The Vaultor's computer account login credentials may be saved in segregated vaults wherein separate access may be provided to separate designated individuals on one or more DDCs. The login credentials may be passed to an executor or proxy whom has administrative level authority to deliver content and/or vault or sub vault access to person(s) pursuant to a DDC.

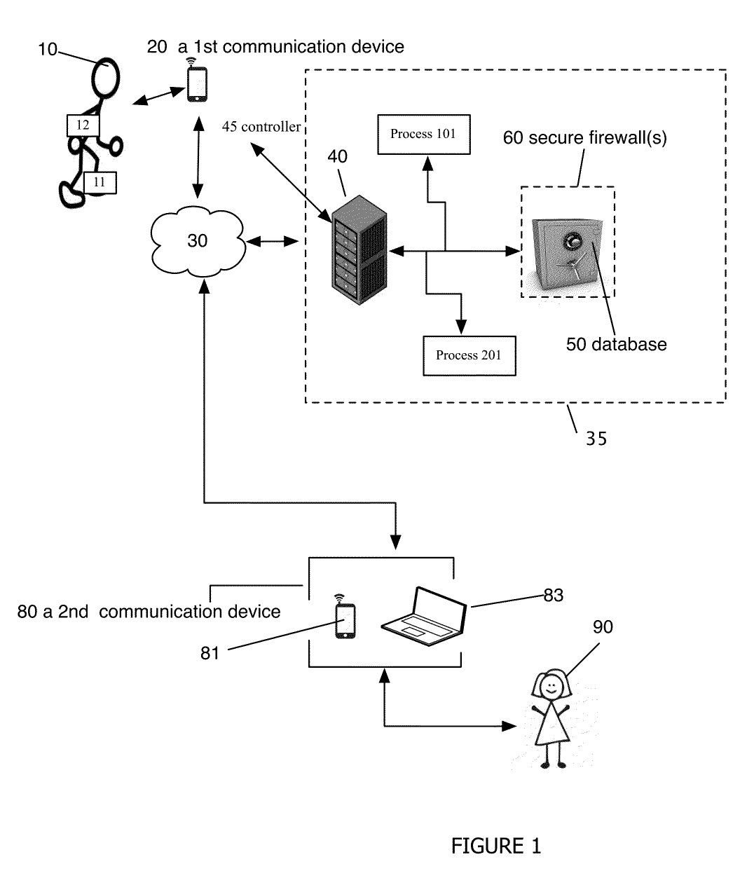

In simplified operation, FIG. 1, discloses aspects of a system and method to capture or store and deliver or release to specified person or persons last message, or other content from a secured vault from an originator (Vaultor) 10.

A Vaultor 10 utilizing a smart phone 20 which is a first communications device in signal communications via a network 30 with a website 35. The smart phone 20 may also have the safe vault application installed. The originator interacts with a safe vault application or the vault website to provide digital content (which may be created via a text or, video, or jpeg or audio function of the smart phone) to the safe vault to be held for delivery if a catastrophic event occurs (i.e. death, disappearance, in capacitance, capture and the like). Rule and/or decision engines provided by one or more of servers 40 and controllers 45 cycle through a process 101 to verify and/or authenticate the originator to vault content for a preselected release or delivery. Rules include verifying if an originator is incarcerated, incapacitated or dead.

In some exemplars such verification is via a trusted friend or designated person. In some exemplars verification is via a web crawler which searches the web for records of the originators status and provides that search result to an administrator for verification. In some exemplars verification is via the loss of contact with an originator for more than a set period of time.

In some exemplars loss of contact refers to the situation wherein the originators biometric are not found on a record accessible through a network. In some exemplars loss of contact refers to the situation wherein the a record of an originators RFID tag, or other implantable device (11) which sends a health or life signal is not found on an record accessible through a network.

In some exemplars loss of contact refers to the situation wherein the originators life signs from a wearable device (12) has not reported a life sign for a predetermined period of time. The interface for setting up the vault verifies and allows the originator to connect the records of life signs via a wearable device or implantable device to the servers 40 whereby the records are verified.

Controllers refers to software which the originator (Vaultor) interacts with to establish authenticity of the Vaultor and to guard and control the release of vault contents to an intended recipient (Vaultee) in the event of a data distribution condition (DDC). The verification may include authentication of the originator credentials, biometrics or other security procedures. Biometrics may include pheromones, voice, face, image, fingerprint ID, ID, breath, DNA, breath and other measures of an individual via their physical or chemical characteristics. In some instances multiple party verification may be specified. The digital content is saved in memory in a database 50 and the database can be secured by one or more of firewalls and encryption 60. In the event of a deliver event (catastrophic event) also called DDC the controller 45 utilizing decision and/or rule engines determines via a process 201 if content is to be delivered. The decisioning process may include collecting data via a robot or web crawler, a news filter, on such subjects as the originators social security number, tax rolls, obituaries, death certificates, news. Records searched may be public or privates. Other sources may be one or more of employers, insurance companies, banks, and hospitals. As previously noted, other sources may include be record of health or life sign of an originator one of cameras, scanners, monitors and the like. Using health information probability of incapacity may be ascertained.

If and when a decision to allow a non-originator to have access to stored content or to apply for delivery or release of the stored content it is done through a computing device which may also be a second communications device 80. The communications device 80 allow a recipient (vaultee) 90 via a smart phone 81 or other computing device 83 to communicate with servers. The process of delivery may also require authentication of the vaultee. That is, merely delivering to a vaultee's smart phone may be inadequate security in some instances. A smart phone or other computing device may be shred or stolen. To maintain higher security the process 201 may include authentication of the vaultee credential, via biometrics or other known security procedures. Biometrics may include voice, face, image, fingerprint ID, facial ID, breath, DNA, breath and other measures of an individual via their physical or chemical characteristics. A record of the vaultee's biometrics may be provided by the vaultor to the servers.

Alternatively a registered member of the safe vault network who is properly identified as a unique individual can have their authentication of the credentials, including biometrics and chemical or other security procedures in an authenticated file.

Alternatively, the safe vault may create one or more of a chemical, security, authentication and biometric record for each Vaultor and be able to leverage that database to authenticate a person who is an originator for his/her own vaults but is a recipient to others.

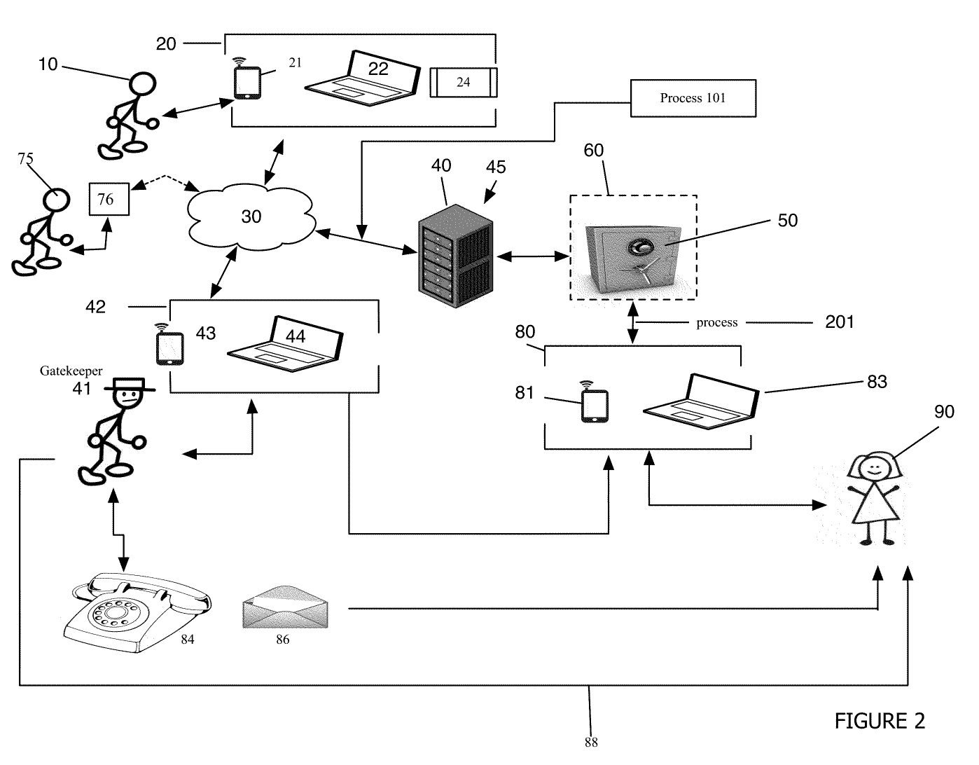

FIG. 2 provides another overview of aspects of a system and method to preordain delivery of last messages and/or content of an originator 10 utilizing a first communication device 20 which may be a smart phone 21, a computer 22 or other device 24 cable of access of a safe vault website. Other devices may include smart TVs, car navigation systems, home robot and security systems, drones and the like. Access may be via an application on the communication device (which in this instance is also a computing device) or via Internet access to a website.

The first communications device is in signal communications with a servers via a private, or public network 30/31 and it interacts with a safe vault application or the vault website to provide digital content (which may be created via a text or, video, or jpeg or audio function of the smart phone) to the safe vault server(s) 40 to be held for delivery if a defined or catastrophic event occurs (i.e. death, disappearance, in capacitance, marriage, graduation, a birthday, a grandchild's birth, the death of another, capture etc.) such events may be referred to as a Data Distribution Condition (DDC. In some instances content may include manual or automatic scrapping the vaultor's FACEBOOK™, LINKEDIN™, TWITTER™, SNAPCHAT™ or other social or professional network and includes securing (in a usable form), passwords and user names for such sites, browsing history, use history, and passwords, user names and the like for online accounts, and also for financial accounts.

In some instances content may include archived emails, documents, pdfs, jpegs, photo library's, cloud, DROPBOX™ and other places vaultor has credential or an account that may have vaultor's digital assets.

In some instances the originator via the smart device 20 may provide one time, limited or unlimited credentials or a key to allow a third party 75 via the third parties computing device 76 whereby an authenticated third party 75 is provided the credentials or a key to add content to the vault 40. The servers 40 must authenticate such a third party before content can be allowed to be added. As previously noted, rule and/or decision engines provided by one or more of the servers 40 and controllers 45 cycle through a process 101 to allow the originator (vaultor) to vault content for a preselected release or delivery in the event of a catastrophic event. The allowance includes authentication of the originator credential, may include biometrics or other security procedures. The content is saved in memory in a database 50 and the database is secured by one or more of firewalls and encryption 60. In some instances a gatekeeper 41 may be appointed by at least one of the originator 10, server 40 and the controller 45. The gatekeeper may be a individual or a entity or a group of individuals. The first communication device 20 is in signal communication with the server 40 and the gate keeper's third communication device 42 (which may include phones 43, laptops 44 and tablets or wearable device not shown). In some the first communication device is communicating with the gatekeepers third communication device to device and in other instances the server 40 acts as an intermediary. In those instances when the gatekeeper 41 has previously agreed to act as a gatekeeper his/her third communication device may be enabled to accept the role of gatekeeper automatically and without the gatekeepers actual knowledge of who the originator is, or if known when the originator made the request. In those instances when the gatekeeper 41 is contacted he/she will have a user interface whereby acceptance of appointment of gate keeper obligations is agreed to.

Although a gatekeeper 41 in some instances will not have access to the materials in the safe vault. The gatekeeper has at least one role to provide the recipients(s) a digital key or credentials to the safe vault and to be at least a part of the decisioning process of whether content should be delivered to a particular recipient. In some instance even the gatekeeper must by authenticated before he/she may be provided a key or credentials for the recipient(s) a registered member of the safe vault network who is properly identified as a unique individual can have their authentication of the credentials, including biometrics and chemical or other security procedures in an authenticated file. Part of the process of being a specific gate keeper selected by originator or of being an ad hoc gate keeper is that the gate keeper has the option of providing an authentication library of data such as security questions, biometrics and chemical to assure that a gatekeeper can be verified prior to delivering even the key or credentials for the recipients to the gatekeeper(s).

In the event of a catastrophic event (also referred to as a Data Distribution Condition (DDC) 500) at least one of the controller 45 via a process 201 and the gatekeeper 41 determine if a digital key or credentials to access content, is to be delivered to a recipient. The decisioning process may be a stepwise process wherein the controller 45 must first communicate with the third communication device before the gatekeeper 41 is provided a key which may be provide from the gatekeeper's to the recipient. Communication to recipient (Vaultee) may by third communication device to second communication device, or it may be via telephone 84, or it may be via hard mail, or by personal contact 88. If and when a delivery or release of the content to a Vaultee 90 is decisioned to occur then via signal communications to a second communications device 80 such as smart phone 81 or other computing device 83 a digital key to retrieve the content—when and if the Vaultee is properly authenticated, is delivered.

In some instances the decisioning process may be a step wise process wherein the controller 45 must first communicate with the third communication device before the gatekeeper is given authority to one of instruct the server 40 to provide a digital key to the safe vault of the originator or provide a digital key (which can only be used by recipient) directly from the third communication device to the second communication device—all in signal communication with each other and having memory, processors, hardware and software.

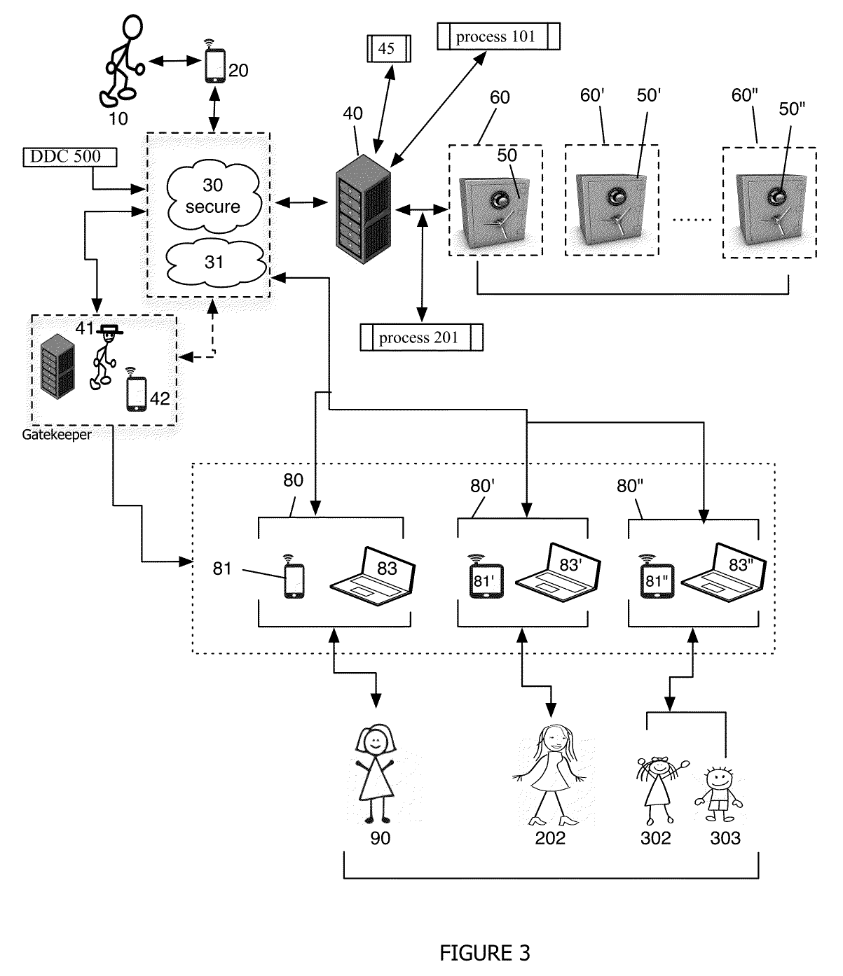

FIG. 3 provides another overview of aspects of a system and method to preordain delivery of last messages and/or content of an originator 10 utilizing a first communication device 20 capable of access the safe vault website via signal communications through a network 30/31. The first communications device is in signal communications with a website via a private, or public network 30/31 and it interacts with a safe vault application or the vault website to provide digital content (which may be created via a text or, video, or jpeg or audio function of the smart phone) to the safe vault server(s) 40 to be held for delivery if a catastrophic event occurs (i.e. death, disappearance, in capacitance, capture and the like). Rule and/or decision engines provided by one or more of the servers 40 and having controllers cycle through a process 201 to allow the originator to vault content for a preselected release or delivery in the event of a catastrophic event. The allowance includes authentication of the originator credential, may include biometrics or other security procedures. The content is saved in memory in one or more databases 50-50″ and the database is secured by one or more of firewalls and encryption 60-60″ the array of vaults may be in the same database or different databases. The access privileges and permissions for each vault 50-50″ may be different. The recipients such as spouse or significant other 90, girlfriend/boyfriend 202, children 302/303 may receive access key(s) for the same or for different safe vaults.

In some instances a gate keeper 41 may be appointed by at least one of the originator 10, server 40 and the controller 45. The gatekeeper may be an individual or a entity or a group of individuals. The first communication device 20 is in signal communication with the server 40. In some instances the originator's first communications device 20 is in communication with the gatekeepers third communications device 42. In some the first communication device is communicating with the server 40 and the server in turn is an intermediary which communicates via signal communications to the third communications device. In those instances when the gatekeeper 41 has previously agreed to act as a gatekeeper his/her third communication device may be enabled to accept the role of gatekeeper automatically and without the gatekeepers actual knowledge of who the originator is, or if known when the originator made the request. In those instances when the gatekeeper 41 is contacted he/she will have a user interface whereby acceptance of appointment of gatekeeper obligations is agreed to.

The gatekeeper does not have access to the materials in the safe vault. The gatekeeper has at least one role to provide the recipient(s) a key to the safe vault and to be at least a part of the decisioning whether the key should be delivered to a particular recipient.

In the event of a DDC at least one of the controller 45 via a process 201 and the gatekeeper determine if a digital key (credential) to allow an intended recipient to try and retrieve content is to be delivered. The decisioning process may be a step wise process wherein the controller 45 must first communicate with the third communication device before the gatekeeper is provided a key which may be provide from the gatekeeper's to the recipient.

In some instances the decisioning process may be a stepwise process wherein the controller 45 must first communicate with the third communication device before the gatekeeper is given authority to one of instruct the server 40 to provide a digital key to the safevault of the originator or provide a digital key (which can only be used by recipient) directly from the third communication device to the second communication device—all in signal communication with each other and having memory, processors, hardware and software.

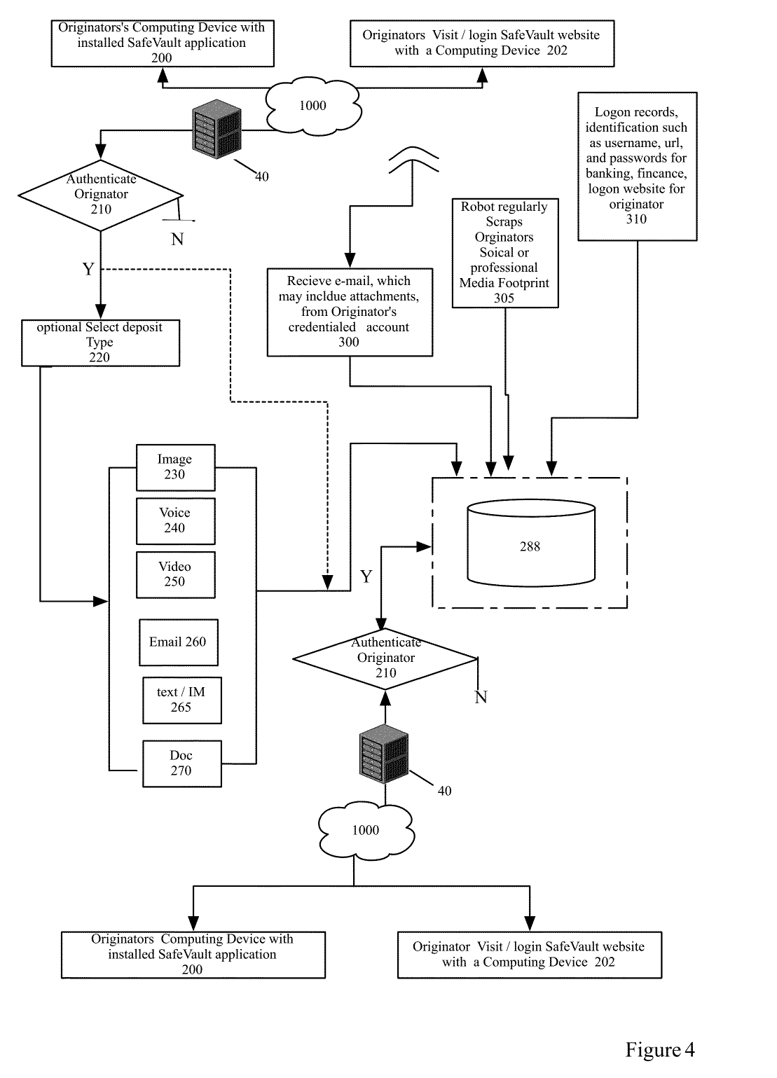

FIG. 4 shows aspects of the method and process of an originator (Vaultor) interacting with a safe vault. The Vaultor using one of a computing device with a safevault application installed thereon 200 and a safevault website 202 to login to view a network 1000 communicates with a server 40. The server 40 authenticates the originator 210 which may include but is not limited to passwords, security questions, device identification (hardware), device location (gps), the IP address, and biometrics. If authenticated then the Vaultor may optionally select a data type for archive 220 categorize may be personalized some can include image (jpeg, pdfs, tiff and the like) 230 voice 240, video 250, email 260, IM (instant message)/text 265 and docs 270 (such as word file, spreadsheet, text, flow diagrams other manipulatable non photo files). That data is stored in a database structure for the safevault 288.

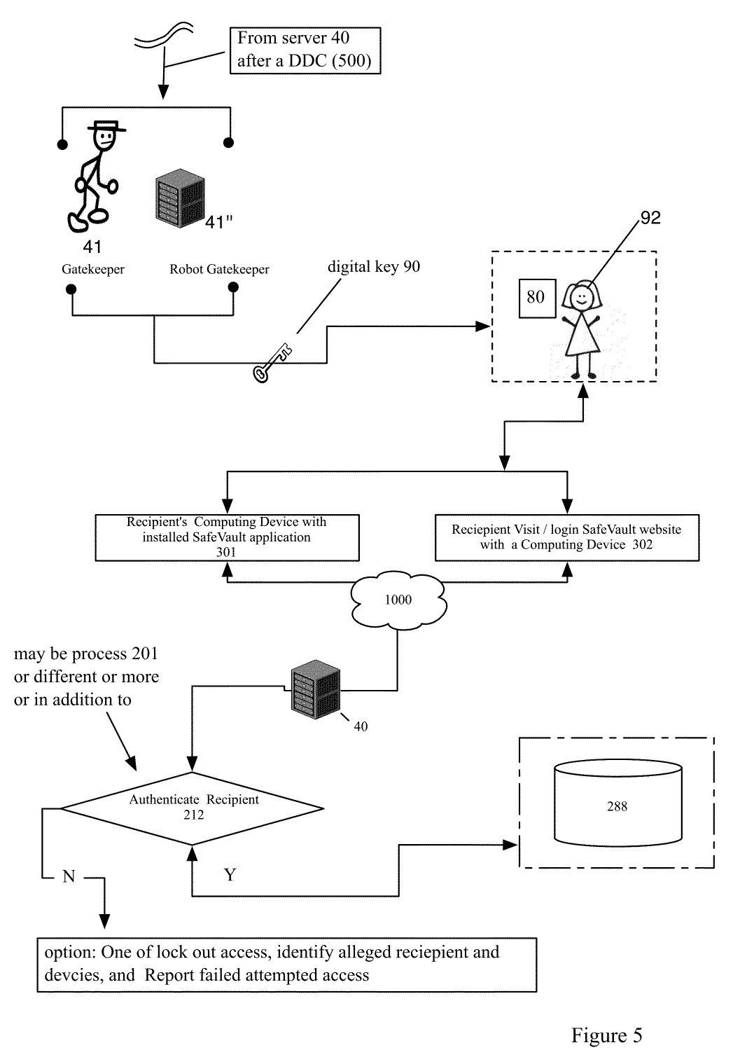

FIG. 5 illustrates aspects of a method and system of a recipient post DDC 500 interacting to try and gain access to safevault content. The server 40 contacts at least one of a gatekeeper 40 and a robot gatekeeper 41 via signal communications to a computing device wherein the gatekeeper(s) provide a digital key 90 to an intended recipient 92. The recipient using a computing device 80 is either communicating with the server via an application 301 or via a website 302. The server then attempts to authenticate the recipient 212. Rule and decision engines in the server go through at least a process 201 to verify or authenticate the alleged recipient. The process may include but is not limited to passwords, security questions, device identification (hardware), IP address, device location (gps), biometrics and confirmation of digital key 90. If authenticated 212 the recipient is allowed the appropriate level of access to the safevault database 288. If the authentication fails the servers may optionally one or more of lock all access to the safevault database 288 and report failed attempted access. The report may include placing the alleged recipient, the computing device, the IP address, the MAC address, machine ID, location, or other identifier on a black list which is one of denied access to the specific safevaults until the threat of a data breach is neutralized and denied access to any safevaults.

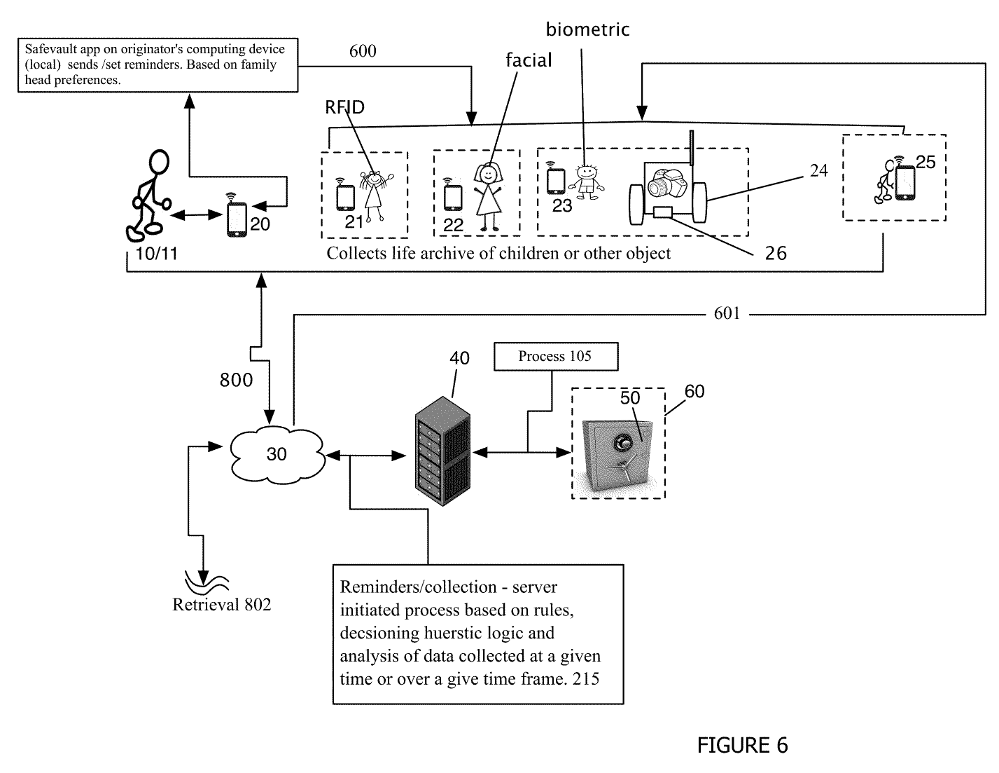

FIG. 6 illustrates aspects of a family data collection. There are two separate and also combined processes which are deployed to urge, cajole or otherwise help a sibling, parent caregiver and/or collector to acquire data about or form a child. Those of ordinary skill in the art will recognize that a child system and method may also be utilized for the elderly, disabled, infirm or mentally incapacitated. Collector means someone such as a legal guardian, caregiver, sibling, relative, or other person(s) authorized by a adult, parent, or guardian to collect digital data on/about the Collection-Target (child or other person). Digital data includes but is not limited to audio, sensory data, video, biometric, voice, medical, physiological statistics such a as breathing, blood sugar, oxygen saturation, cognitive data about actions such as speed, response time, interaction with set tasks or tests, physical test, and chemical. Parents or collector s use this system to collect or acquire digital media and digital data about the Collection-Target. Collection may be distributed among many with each collection device (and person or robot) associated therewith acting as a collection node for that Collection-Target.

In some instances a parent 10 or collector 11 utilizing a GUI with a safevault (or family vault/secure vault) application has set the criteria on a smart phone (or other computing device) 20 to send reminder 600 to the computing devices 21-25 associated with Collection-Target (also referred to as POO) to capture digital data or digital media from or about the Collection-Target Non-human controlled devices may be autonomous, robotic or semi-autonomous computing device 24 such as a drone, JIBO™, home security system, or robot with one or more video, audio, sensory capture devices and speakers or screens (monitor) to communicate with the Collection-Target. The child or person of interest (Collection-Target) may be identified via any known method. Methods to identify a subject child or person include but are not limited to RFID tag, biometric, face, chemical, scent, image, voice, geolocation, or other ID and/or tracking device which may include RFID or GPS implanted or attached thereon to provide target acquisition for robotic or other autonomous or semi autonomous data capture. Such capture may include fixed cameras such as home security or butler systems wherein the child on the grounds of a property that is part of the family network is permission to, or otherwise does, capture the location or identification tag associated with the child. Although not shown, the tracking and capture functions may also be applied to a visitor at a site/pet or other sentient being in movement. The data collected is then sent via signal communications to a network 30 to a server 40 which utilizes a process of decisioning to authenticate 105 the source of the data being collected and if authenticated the data is directed to one or more libraries and/or to one or more vaults or sub vault.. During upload to the vault the server may use facial and voice recognition to add meta data to the digital data to mark, tag, or otherwise categorize it with keywords or other retrieval information. Other data/metadata may include source or capture (the computing device), time, identification means used (i.e. gps, RFID, biometric, scent etc.) and date. Each computing device may also have its own digital key entry to the vault which directs the upload to the correct library, vault or sub vault. Server 40 may also provide notification to the computing device of a parent or collector 10/11 of a new upload.

Those of ordinary skill in the art will recognize that within the scope of this disclosure is applying the collection methods herein to not a child but in some instances any Collection-Target and in some instance the group of POOs and in some instances a focus off collection (FOC) person such as a newsworthy person, a person being investigated, a celebrity, a sex offender, a person on parole, a person with a specified RFID tag, a person with a specific smartphone ID, a person with a chemical tag. A person with a specific biometric, voice, face, and the like.

In some instances a server 40 is allowed to robotically, based on criteria 215, to send reminder 601 to the computing devices 21-24 of, or associated with Collection-Target or the computing devices of the caregiver 25 or other Collector. In some instances a sensor 26 on the robot/drone/JIBO™ etc. triggers a collection. Said sensor may be set to a key word, an activity, movement, interaction between Collection-Targets, sound or command.

Such computing devices may utilize video, audio and sensory capture modules and hardware including microphones, touch screens, sensors, headphones, speakers or screens (monitor) to communicate with the Collection-Target. The Collection-Target may have RFID or other ID and/or tracking devices (discussed above) or utilize other tracking means (chemical, biometric, scent, voice and the like) to provide targeting for robotic or other autonomous or semi autonomous data capture. Such capture may include fixed cameras such as home security or butler systems wherein the child on the grounds of a property that is part of the family network is permission to, or otherwise does, capture the location or identification tag associated with the child. Although not shown, the tracking and capture functions may also be applied to a visitor at a site, a robot, drone, pet or other sentient being in movement at or near the Collection-Target. The data collected is then sent via signal communications to a network 30 to a server 40 which utilizes a process of decisioning to authenticate the source of the digital data being collected and if authenticated the data is added to the proper vault or sub-vault. In some instances the data being processed may trigger an alarm to the Collection-Target and/or to contact a parent or guardian or authorities. Alarms may be rules to decision if a Collection-Target is in need of help or may be in a dangerous situation. During upload to the vault the server may use facial and voice recognition to add meta data to the digital file to categorize the subject matter. Other meta data may include source or capture (the computing device), time and date and gps. Other filtering or addition of useful manipulation of the uploaded that may be utilized during upload includes selecting a codec for video digital media, encrypting the upload, creating thumbnail of lower resolution and smaller size. Each computing device may also have its own digital key entry to the vault (or family vault) which directs the upload to the correct vault or sub vault. Server 40 may also provide notification to the computing device of a parent or other registered person when a data upload/collection is made.

Those of ordinary skill in the art will recognize that within the scope of this disclosure is notification of persons or computers other than a parent or guardian in the case of data collection on not a child but on a person of interest.

In some instances a server 40 is allowed to robotically, based on criteria, send reminder 601 to the computing device 20 of the parent or collector 10/11/25 asking suggestions or pushing them to meet a collection criteria which the server has decisioned has not been met or should be adjusted. In other instances the reminder may be instructions sent to a drone 24.

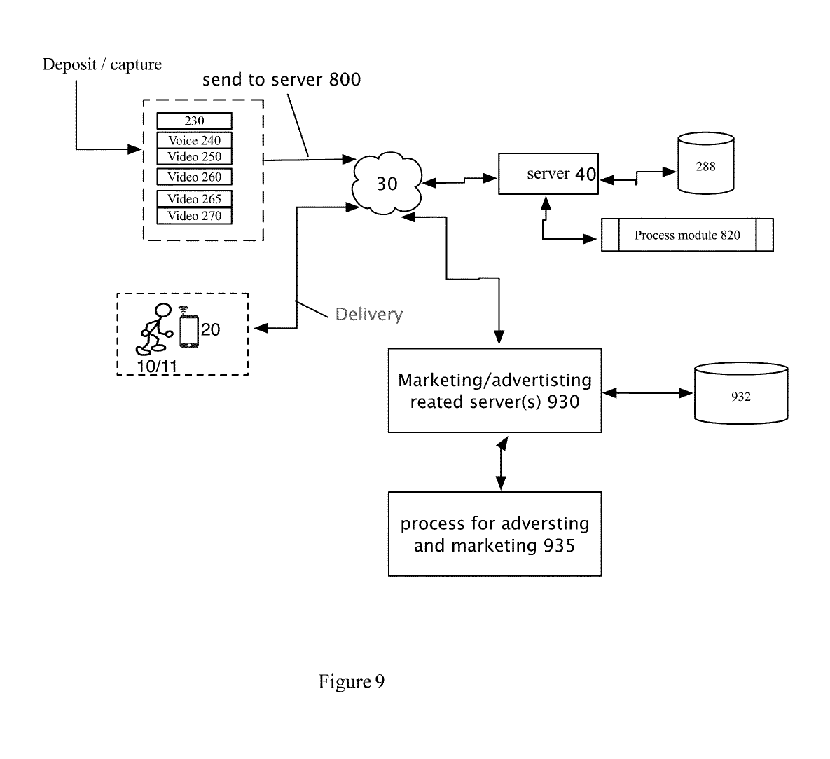

This may result in the drone, parent or collector collecting the scheduled data in those instances when the parent or collector is also a collection node for acquiring collection material. The drone 24, parent 10 or collector 11 may chose to authorize the additional collection schedule and allow the server to robotically collect or the parent 10/collector 11 may adjust his/her computing device to send reminders on a modified schedule. Reminder(s) 600/601 are then sent to computing devices of/or associated with the Collection-Target. The data collected is then sent via signal communications to a network 30 to a server 40 which utilizes a process of decisioning to authenticate the source of the digital data being collected and if authenticated the data is added to the proper safevault or sub-vault. During upload to the vault the server may use facial and voice recognition to add meta data to the digital file to categorize the subject matter. Other meta data may include source or capture (the computing device), time and date and gps. Each computing device may also have its own digital key entry to the vault, safevault (or family vault) which directs the upload to the correct vault or sub vault. Servers may also provide notification to the computing device of a parent when a data upload/collection is made. Retrieval may be via access as previously discussed or may be via push or pull summary or predefined criteria (See FIG. 9).

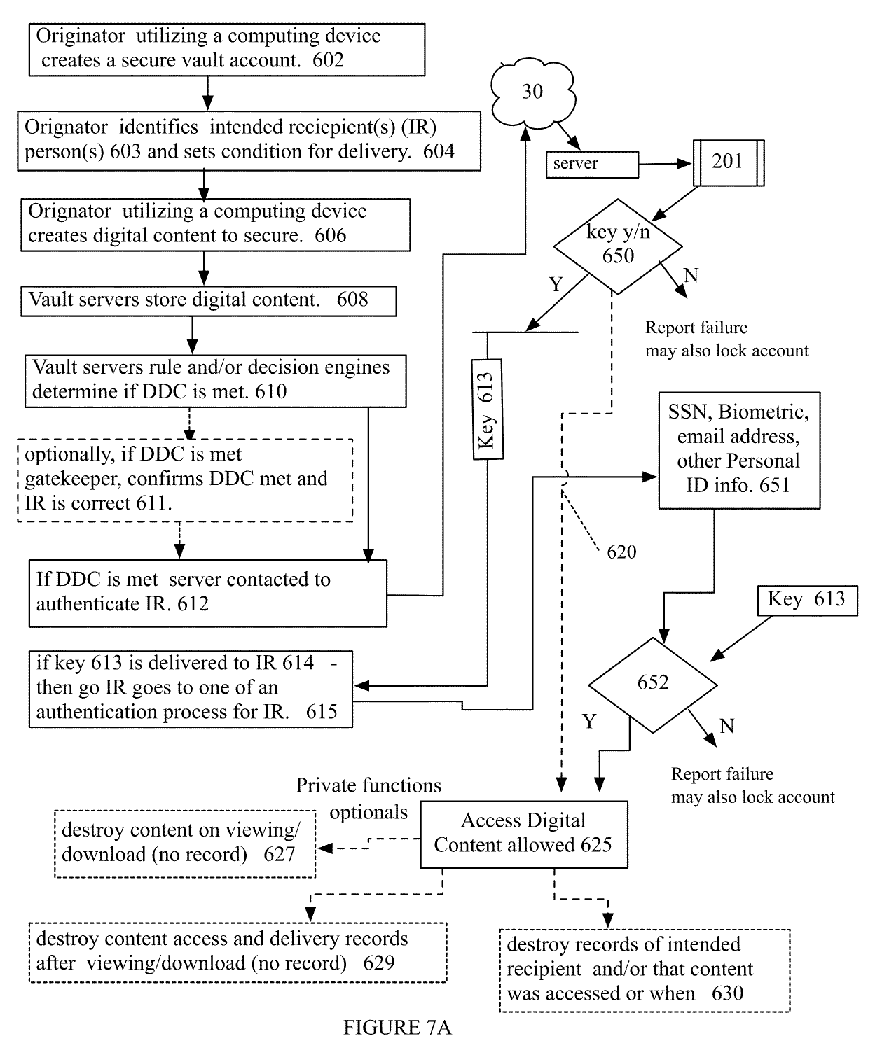

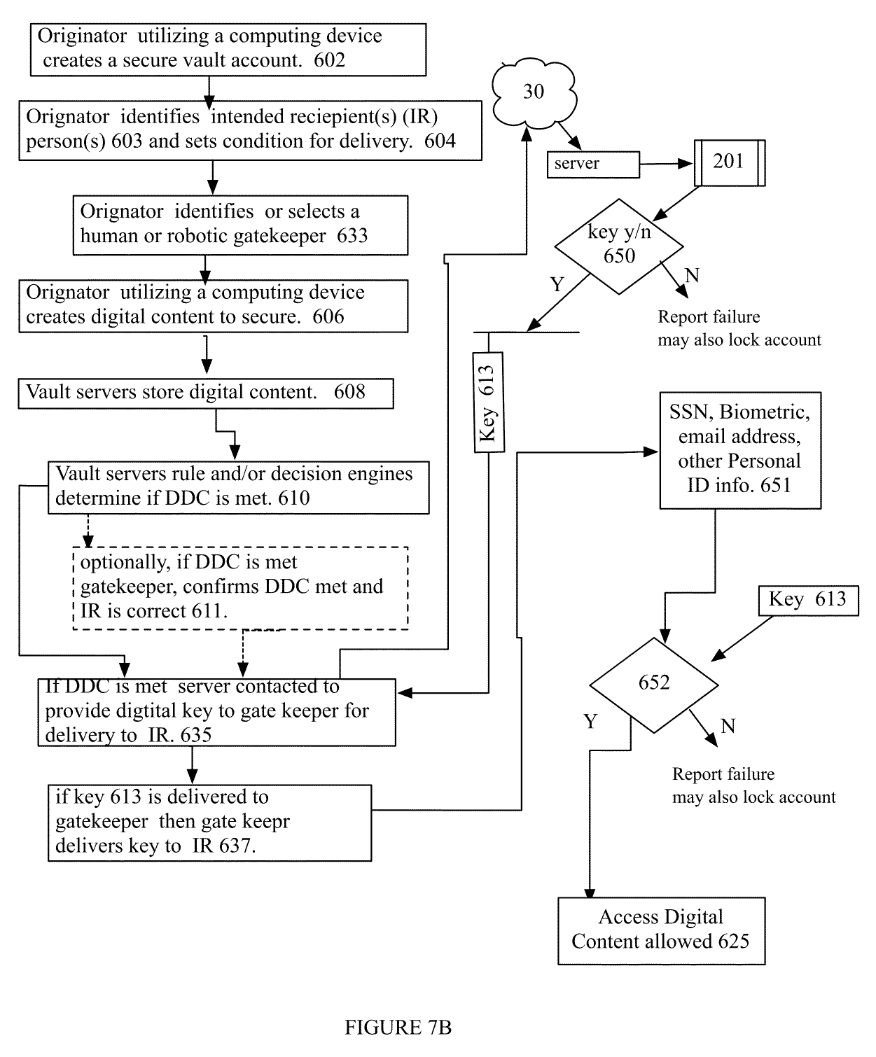

FIG. 7A illustrates some aspects of a workflow for an originator using a secure vault and an intended recipient being provided tools to access digital records. In some instance the intended recipient goes through multiple levels of security screening prior to authentication and being granted access. An originator via a computing device creates a secure vault account 602. An intended recipient, in this exemplary is if said intended recipient is otherwise authenticated.

Once a vault account is created (or during the set-up process) the originator is prompted to identify intended recipient(s) 603. The originator is also prompted to establish DDC (digital Delivery conditions) 604. Prompts may include suggestion regarding social, economic, health, legal and other events which can trigger a DDC. Prompts may also include dates, time or gaps of times that may trigger a DDC. In those instances wherein the originator has linked biometric devices either remote or implanted in user, the data from such devices may be triggers for a DDC, in other instances gps from an implanted tracking device or from a computing device or senor not-implanted but associated with originator may be used.

The originator then utilizes a computing device to create or send data 606. The originator is able to store digital data content 608 in the vault. A very simple example is a first responder storing a audio or video or audio/video message for a loved one or other person in the event that he/she is killed or incapacitated that day. A more complex example is an originator adding voice notes, movie files and specific emails, documents, passwords, scraped social or professional net work user pages etc. as records to be given to the intended recipient(s).

Once the originator account is activated the servers utilizing rule and/or decision engines determine if DDC or DDCs are met 610.

If DDC is met (optionally) a gatekeeper determines at least one of if the DDC is met and is the intended recipient(s) correct 611.

If DDC is considered met by one of server and gatekeeper+server then intended recipient contacts server via computing device and server utilizing a process determines whether or not the key should be delivered 650. If it is not delivered the server optionally contacts the server and/or gatekeeper and reports failure. Server may also lock out account until potential unverified intended recipient/error/fraud is evaluated.

In some instances if intended recipient is authenticated then key 613 delivered to intended recipient 614 then the intended recipient goes through a second round of authentication 651 which may include a variety of security protocols and procedures to verify identify of the intended recipient as well as confirmation of the key 613. In the servers decision 652 that the key and intended recipient are authenticated then access to digital content in vault is allowed 625.

In some instances if intended recipient is authenticated then key 613 is utilized by the server to allow 620 intended recipient (with only one round of authentication) access to digital content in vault is allowed 625. In either instance the originator had previously been provide the optional choices to set private functions to manage content post access. In some instances that private function may be to destroy some or all content (as specified) upon one or more viewing, access or a download 627. The system may be restricted to allow only viewing or download. In some instances the settings may be to destroy digital content access records after a viewing/download 629. In some instances the settings may be to destroy records of one or more of intended recipient and that content was accessed or when 630.

FIG. 7B illustrates some aspects of a workflow for an originator using a secure vault and an intended recipient being provided tools to access digital records. In some instance the intended recipient goes through multiple levels of security screening prior to authentication and being granted access. An originator via a computing device creates a secure vault account 602. An intended recipient, in this exemplary is if said intended recipient is otherwise authenticated.

Once a vault account is created (or during the set-up process) the originator is prompted, preferably through a GUI, to identify intended recipient(s) 603. The originator is also prompted to establish DDC (digital Delivery conditions) 604. Prompts may include suggestion regarding social, economic, health, legal and other events which can trigger a DDC. Prompts may also include dates, time or gaps of times that may trigger a DDC. In those instances wherein the originator has linked biometric devices either remote or implanted in user, the data from such devices may be triggers for a DDC, in other instances gps from an implanted tracking device or from a computing device or sensor not-implanted but associated with originator may be used.

The originator utilizing a computing device in signal communications with a server, preferably through a GUI identifies or selects a human or robotic gatekeeper 633.

Once a secure vault for originator has been established, the originator can create or send 606 digital data content for storage 608. A very simple example is a first responder storing a audio or video or audio/video message for a loved one or other person in the event that he/she is killed or incapacitated that day. A more complex example is an originator adding voice notes, movie files and specific emails, documents, passwords, scraped social or professional net work user pages etc. as records to be given to the intended recipient(s).

Once the originator account is activated the servers utilizing rule and/or decision engines determine if DDC or DDCs are met 610.

If DDC is met (optionally) a gatekeeper determines at least one of if the DDC is met and is the intended recipient(s) correct 611.

If DDC is considered met by one of server and gatekeeper+server then if DDC is met the server is contacted to provide a digital key to gatekeeper for delivery to intended recipient(s). 635. The gatekeeper contacts server via computing device and server utilizing a process determines whether or not the key should be delivered 650. If it is not delivered the server optionally contacts the server and reports failure. Server may also lock out account until potential unverified intended recipient/error/fraud is evaluated.

If gatekeeper is authenticated then key 613 delivered to gatekeeper. Gatekeeper in turn delivers key to intended recipient 637. The intended recipient goes through a second round of authentication 651 which may include a variety of security protocols and procedures to verify identify of the intended recipient as well as confirmation of the key 613. In the servers decision 652 the key and intended recipient are authenticated then access to digital content in vault is allowed 625.

In either instance the originator had previously been provide the optional choices to set private functions to manage content post access. In some instances that private function may be to destroy some or all content (as specified) upon one or more viewing, access or a download. The system may be restricted to allow only viewing or download. In some instances the settings may be to destroy digital content access records after a viewing/download. In some instances the settings may be to destroy records of one or more of intended recipient and that content was accessed or when.

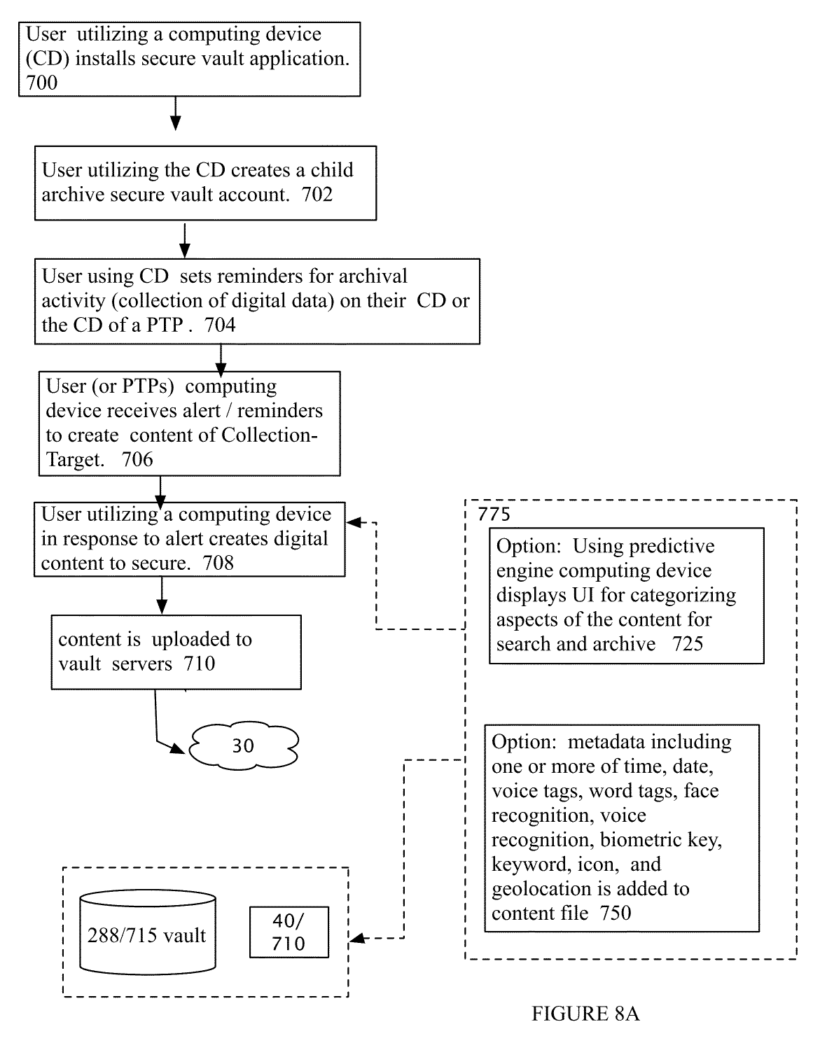

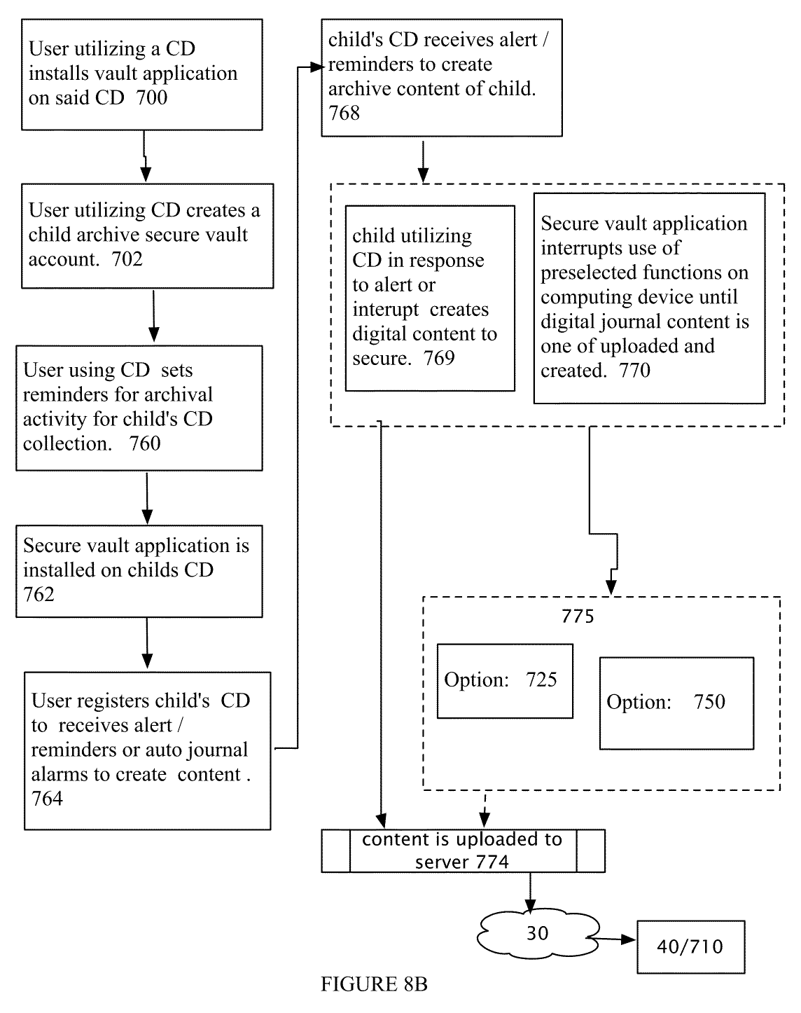

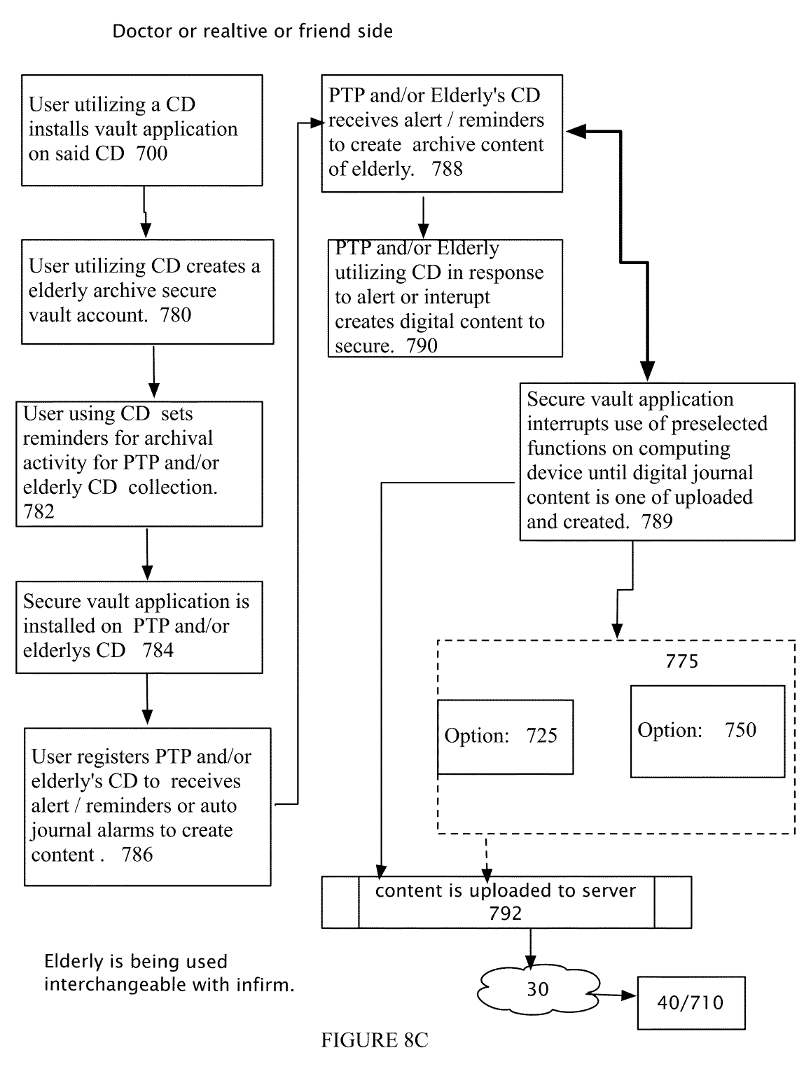

FIGS. 8A-8C illustrates aspects of the processes and workflow for a system to capture and transmit data in accordance with reminders and other Collection-Target processes or criteria.

In this non-limiting example FIG. 8A shows aspects of methods and systems to utilize a secure vault may include User utilizing a computing device (CD) installs secure vault application 700 whereby the user's computing device using signal communications can push and pull via a wired or wireless network from a safe or secure vault server. The user utilizes a computing device to create a secure vault account to receive deposits from child 702. User using CD sets reminders for archival activity (collection of digital data) on their CD or the CD of a PTP 704. Archival activity includes capture of data from Collection-Target.

In some instances the PTP or User's computing device receives alert/reminders to create digital content of a child (or other Collection-Target) such as a pop or push notification on a smart phone wherein the user is reminded to capture the child 706. The notification could push to calendars or outlook. In some instances the reminder system includes and interrupts that requires the user to affirmatively chose not to capture the digital content which the user has set criteria on the system to reminder he/she to capture. In some instances the PTP in response to reminder utilizing a computing device creates/captures digital content 708. In some instances the User or PTP will have right to by-pass the reminder and not collect data, in other instances the reminder may lock some or all smart phone functions except emergency call until a collection is obtained. For a PTP, the collection or by-pass may be reported to the server and a notice to the User other designated person.

Captured content is uploaded to vault servers 40/710, through a network 30 and then stored in a database 288/715 vault. Alternatively collected content is directed to a filtering rule and/or decision engine 775 which may includes using predictive engine for categorizing aspects of the content for search and archive 725. The filtering may include processing metadata such as one or more of time, date, voice tags, word tags, chemical, biologic, DNA, RNA, pheromone, recognition, voice recognition, biometric key, keyword, icon, and geolocation is to the digital content file 750. The categorization may happen all or in part at one or both of the smartphone and server.

In another non-limiting example FIG. 8B shows aspects of methods and systems to utilize a secure vault may include User utilizing a computing device (CD) installs secure vault application 700 whereby the user's computing device using signal communications can push and pull via a wired or wireless network from a safe or secure vault server. The user utilizes a computing device to create a secure vault account to receive deposits from child 702.

The user using a CD sets reminders for archival activity for child's CD for data collection 760. A vault application is installed on child's CD 762. User registers child's CD to receives alert/reminders or auto journal alarms to create content 764.

Child's CD receives alert/reminders to create data for archive content of child 768. Next, one of two options are available. Option one is the collection, and option two is an interrupt.

Collection option is when the child utilizing CD in response to alert or interrupt creates digital content to secure 769. Content may be free form, it may be in response to questions or images, it may be in response to a FACETIME™ or other video chat, it may be in response to an audio or video file being shown to child on a computing device such as a smart television, in house platform including but not limited to JIBO™ or ECHO™, drone, robot and smartphone. Collected content can be uploaded 774 to a server 40/710 via a network 30. Alternatively collected content is directed to a filtering rule and/or decision engine 775 which may includes using predictive engine for categorizing aspects of the content for search and archive 725. The filtering may include processing metadata such as one or more of time, date, voice tags, word tags, face recognition, voice recognition, biometric key, keyword, icon, and geolocation is to the digital content file 750. The categorization may happen all or in part at one or both of the smartphone and server.

Interrupt option is when the secure vault application interrupts use of preselected functions on computing device until digital journal content is one of uploaded and created 770. Collected content can be uploaded 774 to a server 40/710 via a network 30. Alternatively collected content is directed to a filtering rule and/or decision engine 775 which may includes using predictive engine for categorizing aspects of the content for search and archive 725. The filtering may include processing metadata such as one or more of time, date, voice tags, word tags, face recognition, voice recognition, biometric key, keyword, icon, and geolocation is to the digital content file 750. The categorization may happen all or in part at one or both of the smartphone and server.

In some instances the data being processed may trigger an alarm to the Collection-Target and/or to contact a parent or guardian or authorities. Alarms may be rules that decision that a threshold value indicating a Collection-Target needs help or may be in a dangerous situation has been met.

In another non-limiting example FIG. 8C shows aspects of methods and systems to utilize a secure vault may include User utilizing a computing device (CD) installs secure vault application 700 whereby the user's computing device using signal communications can push and pull via a wired or wireless network from a safe or secure vault server. The user utilizes a computing device to create a secure vault account to receive deposits from or about elderly 780.

User using a CD sets reminders for archival activity for PTP or elderly's CD for data collection 782. Secure vault application is installed on PTP or elderly's CD 784. User registers PTP and/or elderly's CD to receives alert/reminders or auto journal is to create content 786. PTP or elderly's CD receives alert/reminders to create data for archive content 788. Next, one of two options are available. Option one is the collection, and option two is an interrupt.

Collection option is when the elderly or PTP utilizing CD in response to alert or interrupt creates digital content to secure 790. Collected content can be uploaded 792 to a server 40/710 via a network 30. Alternatively collected content is directed to a filtering rule and/or decision engine 775 which may includes using predictive engine for categorizing aspects of the content for search and archive 725. The filtering may include processing metadata such as one or more of time, date, voice tags, word tags, face recognition, voice recognition, biometric key, keyword, icon, and geolocation is to the digital content file 750. The categorization may happen all or in part at one or both of the smartphone and server.

Interrupt option is when the secure vault application interrupts use of preselected functions on computing device until digital journal content is one of uploaded and created 789. Collected content can be uploaded 792 to a server 40/710 via a network 30. Alternatively collected content is directed to a filtering rule and/or decision engine 775 which may includes using predictive engine for categorizing aspects of the content for search and archive 725. The filtering may include processing metadata such as one or more of time, date, voice tags, word tags, face recognition, voice recognition, biometric key, keyword, icon, and geolocation is to the digital content file 750. The categorization may happen all or in part at one or both of the smartphone and server.

In the above instances those of ordinary skill in the art will recognize that in many cases a POO or other Collection-Target may be substituted for the child without departing form the scope the disclosure.

In some instances the data being processed may trigger an alarm to the Collection-Target and/or to contact a guardian or authorities. Alarms may be rules that decision that a threshold value indicating a Collection-Target needs help or may be in a dangerous situation ahs been met.

FIG. 9 illustrates aspects of systems for preparing archived digital content and media for use, storage, retrieval, review and delivery of a defined content reel. A content reel refers to collection of capture data which has been parsed into a predetermined grouping. A reel is a term used to identify a virtual film reel of content which may be still image, video, audio, olfactory, health data, documents and the like.

Once instructed the server 40 constructs (processes) a review reel, which may include augmenting a previous reel of data content. The processing takes into account criteria, or presets or selections. Construct as used here means to identify database records and create a sequential map of which can be provided to a user or reviewer or archive owner in a coherent organized fashion based on criteria. The same collection of digital media and records can be used to construct a multitude of reels based on user choices. The delivery may be push to user or pull by user. That delivery is to a specific computing/viewing device. Once delivered the permitted recipient computing device may be used to add content, explanation, data stream (such a narrative) and keywords or connections to other content to the content. User or users are person or systems that have authorized access to the content of the reel.

In this method and system a user 10/11 interacts with a computing device (CD) having an application installed thereon or with a website via a user interface through a network 30 via signal communications to a server 901. The server authenticates 902 the user. If authenticated the user may then interact with a content shaping module (CSM) 903. A non-limiting example is a CSM illustrated with only three options. Those of ordinary skill in the art will recognize that having additional options is within the scope of this disclosure. Option A the user selects a preset of criteria for constructing a reel 905. Option B the user defines the criteria for constructing a reel 907. Criteria may include defining the reel by one or more of collection device(s), geographic location(s), time, date subject(s) via biometric, facial, voice or the like. Example: User may select all digital media with Bobby but none with Amy. The user may select cat climbing but not cat sleeping. The user may select Amy's birthday age 8 which would be connected to a date and/or event as well as subject. The user may select Bobby's response to question cues over the dates of Apr. 1, 2014-Apr. 7 2104. Deep learning and other machine systems able to discern content in images and audio may be applied to sort through the collected content based on user rules and requests.

Option C the server suggests criteria based on server with a heuristic or predictive engine 909. User may be provided suggestion from the machine (server)) for the content of a reel. The predictive engine may use the Predictive Analytics Module “PAM” 910 to develop suggestions based on one or more alternatives. In some instances the suggestions may be based on scraping from other family vaults to trend spot. Trend spotting may include repetitive uses of words, geolocation, objects, questions asked by users to Collection-Targets 911. The servers utilize heuristic engines(s) evaluate/analyze queries to a child from a population of parent/collectors or trend professional (i.e. teachers, doctors and pundits) and identify or predict trends for queries. Trends may be made available to other parent or collectors whereby such other parent/collectors may follow one or more trends in their inquires to their child. For example what is celebrity “A” asking her child? What is my sister asker her child? What does Dr. X believe children should be queried with? In other instances the trends identified or predicted may be used by the server to amend of augment questing or inquiry to a child subject. A simple example in a demographic (age under 12) may be identifying a trend based on a food, media character, movie character, a song, a toy or a food. That trend can be used to predict that a child of X age and Y sex is more likely to respond to such a query. Another predictive query may be formulated by having the servers identify repeat words or images in digital media collected around a child. If a child is talking about a toy, icon, subject/item, for example BUZZ LIGHTYEAR™ or always playing with MEGATRON™, drawing a BARBIE™ and the like once the machine learning identifies the item and frequency of talking about, drawing, playing with or watching the object the system may place inquires via verbal, auditory, written or image in cue for use in collecting digital media. For example, ask Emily to draw a pony. Or ask Albert what does MEGATRON™ eat. In these ways a child's imagination can be shared via the collection and/or in trends may be sent to parent/collector for possible inclusion in future questing. In some instance with deep learning machines may ask the questions based on dynamic trending automatically without parent/collector approval.

Machine (server) suggestions can be based on the types of user presets of other users. Ten thousand other users may show a trend towards certain presets or identifiers. By having the servers 40 as part of a private network, although content collected s intended to be private archives, the servers can track choices in constructing reels and offer those choice and trends to other users without sharing content. The server may also filter content and make suggestions on quantity of subject matter content.

All of the above predictive inquires for collection may also be applied to Elderly. Trends in communicating with elderly or interfacing on subjects their demographic may be more likely to respond to is equally applicable. Subjects may include topics such as health concerns, isolation, cognitive functions.

In other instances suggestion may derive from server engine analysis of a user's prior data deposit 912. In some instances suggestion may be based on the subject matter, age, location, date or user 913. In some instances suggestions may be based on data analysis of linked family accounts 914.

The function of the CSM module is to process 915 the collection of data and one or more of store the data compiled into a reel 920 and deliver the compilation 925.

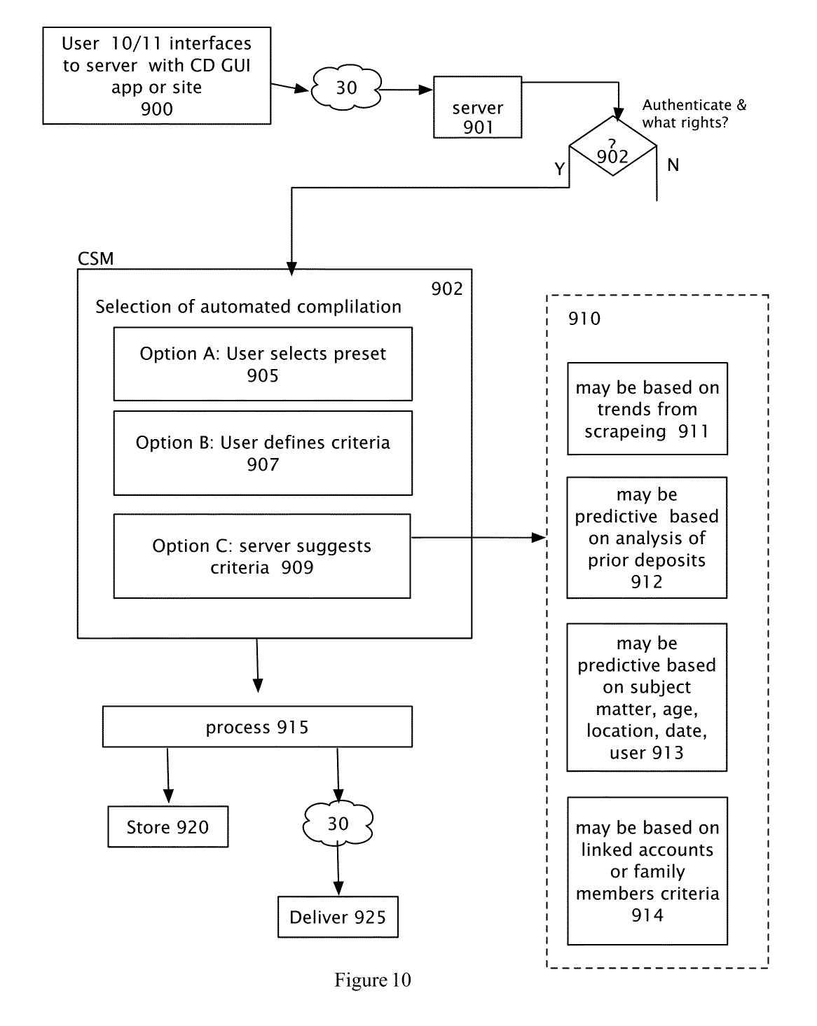

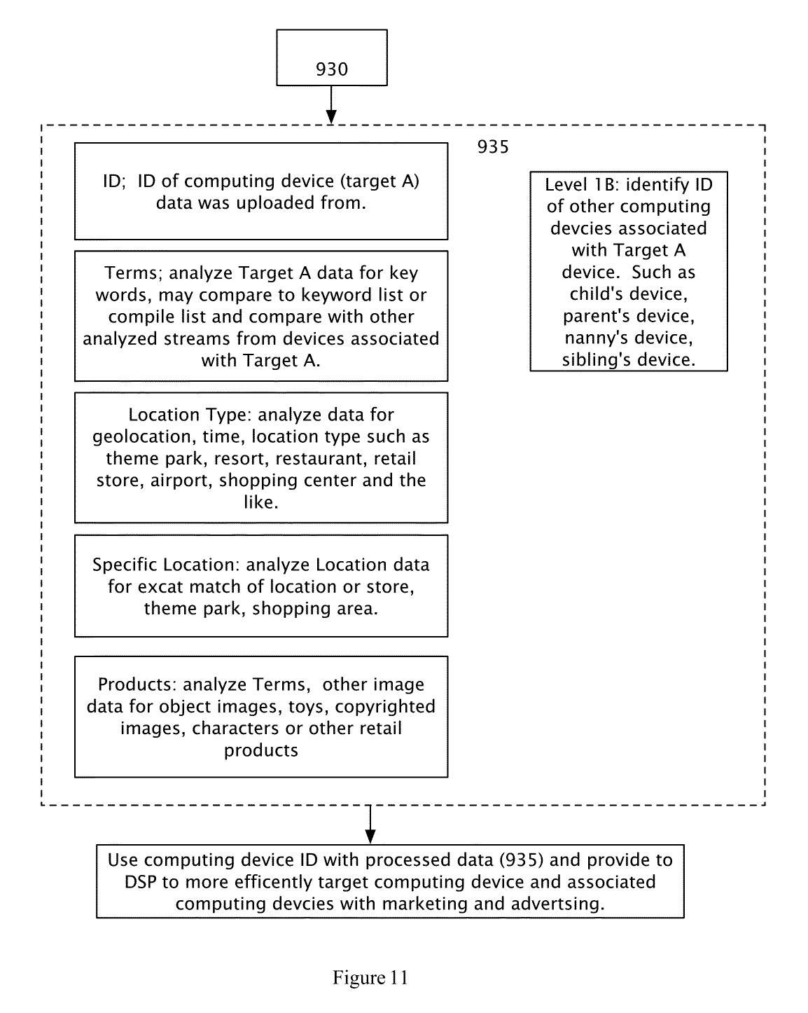

FIGS. 10 and 11 illustrate a system in which server(s) which analyzes the data deposits for purposes of marketing and advertising. Use of the collected data is via a digital sales system “DSS” which includes one or both of a DMP and DSP with a filtered a collection of information from one or more of family archives for one or more of trends, demographic information, geolocation, activity, items, objects consumer information, religious information, and social information for marketing. In some instances the server has in its database purchasing history, and browsing history for the vault depositor and/or the CD/machine ID of that associated with the deposit.

Deposits 800 are sent via signal communication 810 to server 40 through a network 30 to be archived in private family vaults for users of the system. This is a private archive. The server 40 processes 825 the deposits scarping data and metadata. The server than sends the processed information to marketing and advertising server(s) 930 which may store the data in a database 932 and process 935 the data and meta data.

The collected data may include geolocation of the CD, the CDs machine ID, user of CD demographic data such as age and sex. In some instance browsing history may also be correlated to the Users CD machine ID. The collection may also correlate geolocation change with machine ID for CD. For example if smartphone 123 has gone from Atlanta to Orlando and making deposits while at Disneyworld that suggests a marketing or advertising opportunity which is different than if smartphone XYZ has left Flagstaff and is in Sedona. Alternatively it may be object data that is scarped. If deposits show LEGO™ being built over and over that may be meaningful. If audio recordings repeat a word that can be correlated a sellable thing (service or product) that may be meaningful.

Processing of the collected/deposited digital data may be at the archive server 40, the marketing advertising server 930 or at both. Processing may include other records, from other sources which contain purchasing history, browsing history of user and/or geolocation of user's CD.

Once processed data, which may include CD ID correlated to data and meta data on services and products that may resonate with recipient are provided to the DSP.

A target recipient 945 who may also be a user is then the subject to targeted advertising and marketing 950.

It will be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

What is claimed is:

1. A secure digital content collection method, the method comprising: a server being in signal communications with an application on a computing device which may be a smartphone on a member of a population of objects (POO) or on a member of a population of third parties collectors for a POO (PTP); and, the computing device receives a prompt from the server or application on the smartphone to collect digital data at a pre-determined time or date.

2. The method of claim 1, the method further comprising the member of the POO or PTP in response to the prompt either captures data and deposits it in a safe vault or does not make a data capture or deposit.

3. The method of claim 2, the method further comprising the if the member of the POO or PTP does not make a capture one or more functions on the computing device it is interrupted until a capture is confirmed by the application or servers.

4. The method of claim 2, the method further comprising the if the member of the POO or TPT does not make a deposit of a data capture one or more functions on the computing device is interrupted until the deposit is confirmed by the application or servers.

5. The method of claim 3 wherein notice of a failure to make a data capture or deposit which causes an interrupt is provided to a designated person.

6. The method of claim 4 wherein notice of a failure to make a data capture or deposit which causes an interrupt is provided to a designated person.

7. A autonomous or semi-autonomous digital data collection system; the system comprising:
one or more data collection devices on a home platform, laptop, smart TV, smartphone, robot, fixed device and drone;
the data collection device also being a computing device;
a server in signal communications with the digital capture device;
one of the server and a timer on the collection device instructs the data collection device to collect data on a POO or PTP;
the collection device identifies the POO or TPT for collection; and, whereby the collection of data from the POO or PTP is taken.

8. The method of claim 7, wherein the captured digital is uploaded to a secure vault.

9. The method of claim 7, the wherein the identification of the POO or TPT via biometrics such as face, voice, pheromones associated with the POO or TPT.

10. The method of claim 7, the wherein the identification of the POO or TPT via the device ID of a smartphone associated with the POO or TPT.

11. The method of claim 7, wherein the identification of the POO or TPT via the device ID of a RFID tag associated with the POO or TPT.

12. The method of claim 8, the method further comprising access of uploaded content by an authorized person.

13. The method of claim 8, the method further comprising servers filtering uploaded content according to criteria to prepare an reel.

14. The method of claim 13 wherein the reel is delivered to a user.

15. The method of claim 13 wherein the criteria are at least one of a preset, user defined, server heuristic or predictive engine selected

16. An advertising method, the method comprising: a server being in signal communications with a secure vault server receives data and metadata collected or scraped from deposits of the one or more secure vault depositors which may include device ID of depositor, meta data about the user of the device, keywords, images, locations, purchasing history, and browsing history; and, the scraped data is used, at least in part by a data management platform and a demand-side platform.

17. The method of claim 16, wherein the collected data is used to advertise.

18. The method of claim 16, wherein the server has additional data and meta data associated with the depositor such as geolocation, age, browsing history and CD associated with depositor machine ID.
